(19) United States
(12) Patent Application Publication
(10) Pub. No.: US 2013/0114647 A1
(43) Pub. Date: May 9, 2013

(54) COMMUNICATIONS RELAY SYSTEM AND RELAY DEVICE IN THE SAME

(71) Applicant: Denso Corporation, Kariya-city (JP)

(72) Inventor: Tomoyuki Koike, Nagoya-city (JP)

(73) Assignee: DENSO CORPORATION, Kariya-city (JP)

(21) Appl. No.: 13/663,713

(22) Filed: Oct. 30, 2012

(30) Foreign Application Priority Data
Nov. 4, 2011 (JP) 2011-242454

(51) Int. Cl. H04B 3/36

(52) U.S. Cl. 375/211

(57) ABSTRACT

A communications relay system for establishing data communications between an external device and a plurality of communication devices. In the system, the plurality of communication devices and a relay device are connected to a communication path to form a communication network. The relay device is operable to relay communications between the external device and the plurality of communication devices when being connected to and powered by the external device. With this configuration, the system is capable of reducing power consumption in the relay device to thereby reduce power consumption over the communication network.

### CROSS-REFERENCE TO RELATED APPLICATION

This application is based on and claims the benefit of priority from earlier Japanese Patent Application No. 2011-242454 filed Nov. 4, 2011, the description of which is incorporated herein by reference.

### BACKGROUND

1. Technical Field

The present invention relates to a communications relay system and a relay device therein for connecting an external device to a communication network formed of a plurality of communication devices connected to a communication path.

2. Related Art

A known in-vehicle communication system uses a communication bus, such as a Controller Area Network (CAN) bus or a Local Interconnect Network (LIN) bus. In such an in-vehicle communication system, a communication network is formed of a plurality of electronic control units (ECUs) connected to the communication bus, where each of the ECUs serves as a node.

An eternal device may be connected to such an in-vehicle communication network to diagnose a failure of each node or to provide an additional function to the in-vehicle communication system. For example, a diagnostic tester, which is an external device, may be connected to the in-vehicle communication network to diagnose a failure of each node on the basis of a response of the node to a diagnostic request from the diagnostic tester.

A relay device may be provided between an external device and the in-vehicle communication network to perform communication protocol conversion therebetween. For example, when an external device communicable with an Ethernet® protocol is connected to the in-vehicle communication network, the relay device performs the communication protocol conversion between the CAN protocol used in the in-vehicle communication network and the Ethernet® protocol used by the external device.

A relay device may also be provided between an external device and the in-vehicle communication network to determine whether or not the external device is authorized and thereby prevent unauthorized tampering. For example, the relay device determines whether or not a frame outputted from the external device is valid, and when it is determined that the fame is valid, then forwards the frame to the in-vehicle communication network of the communication system.

In recent years, there lies a challenge to have an in-vehicle communication system having not only improved performance, but also power-saving capability. To this end, a relay device may be pre-incorporated in the in-vehicle communication network, where an external device may be connected to the in-vehicle communication network through the relay device. Such a relay device, however, has to be always supplied with electrical power from a vehicle so that the relay device can operate whenever the external device is connected to the in-vehicle communication network. Therefore, there still lies a challenge to reduce power consumption in the relay device.

As a solution to this, as disclosed in Japanese Patent Application Laid-Open Publication No. 2009-290271, a relay device having various functions is controlled so that only unnecessary functions are suspended when an external device is not connected to the in-vehicle communication network.

As above, in the disclosed solution, power is saved by suspending not all, but some of the functions of the relay device. Power feed to the relay device is therefore not fully interrupted. As such, the power feed to the relay device may still remain wasteful.

There is known a selective wake-up mode of the in-vehicle communication system, in which power is saved by interrupting power feed to each node. It can therefore be envisaged that the relay device may also be controlled to sleep in the selective wake-up mode. This, however, may lead to a more complicated hardware or software configuration for enabling the relay device to cooperate with the other nodes.

The in-vehicle communication network provided above is exemplary. A communications relay system, in which a relay device is pre-incorporated in a communication network formed of a plurality of personal computers, has also similar disadvantages as above.

In consideration of the foregoing, it would therefore be desirable to have a communications relay system, in which a relay device is operable to connect an external device to a communication network, capable of reducing power consumption in the relay device to thereby reduce power consumption over the communication network.

### SUMMARY

In accordance with an exemplary embodiment of the present invention, there is provided a communications relay system for establishing data communications between an external device and a plurality of communication devices. The system includes: a communication path to which the plurality of communication devices are connected to form a communication network; and a relay device connected to the communication path as a part of the communication network and operable to relay communications between the external device and the plurality of communication devices when being connected to and powered by the external device.

Conventionally, a relay device as a part of the communication network is supplied with power from the communication network. This may lead to wasteful power feed from the communication network to the relay device, for example, when an external device is not connected to the relay device, or may lead to a more complicated hardware or software configuration for deactivating the relay device.

The relay device only has to operate when an external device is connected to the communication network through the relay device. The relay device is therefore advantageously configured to be supplied with power from the external device. With this configuration, the relay device can operate only when the external device is connected to the relay device, which leads to power saving in the relay device and thus to power saving across the communication 10 network.

### BRIEF DESCRIPTION OF THE DRAWINGS

In the accompanying drawings:

FIG. 1 is a schematic block diagram of a communications relay system in accordance with a first embodiment of the present invention;

FIG. 2A is a schematic block diagram focused on power feed from a diagnostic tester to a GW-ECU in accordance with the first embodiment;

FIG. 2B is a schematic block diagram focused on power feed from a diagnostic tester to a GW-ECU in accordance with a second embodiment;

FIG. 3A is a timing diagram for the power feed from the diagnostic tester to the GW-ECU in accordance with the first embodiment;

FIG. 3B is a timing diagram for the power feed from the diagnostic tester to the GW-ECU in accordance with the second embodiment;

FIG. 4 is a flowchart for a power-feed control process in accordance with the second embodiment; and

FIG. 5 is a schematic block diagram of a communications relay system in accordance with a variant of the first embodiment.

### DESCRIPTION OF SPECIFIC EMBODIMENTS

The present inventions will be described more fully hereinafter with reference to the accompanying drawings. Like numbers refer to like elements throughout.

### First Embodiment

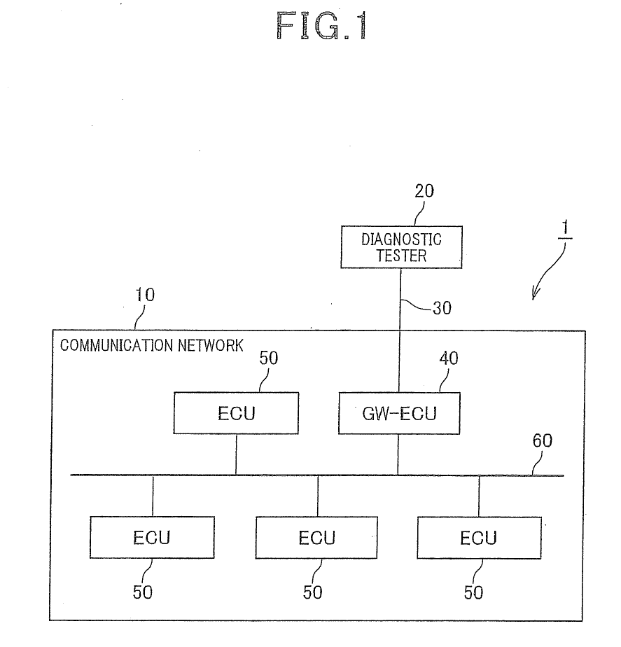

FIG. 1 schematically shows a block diagram of a communications relay system 1 in accordance with a first embodiment of the present invention. The communications relay system 1 includes an in-vehicle communication network 10 and a diagnostic tester 20. In the communication network 10, serial communications are made by use of the Controller Area Network (CAN) protocol.

The diagnostic tester 20 is connected to the communication network 10 by a communication path 30 via a data link connector (not shown). The communication network 10 includes a gateway ECU (hereinafter referred to as a “GW-ECU”) 40, to which the diagnostic tester 20 is connected, and a plurality of ECUs 50. Serial communications are made between the diagnostic tester 20 and the GW-ECU 40 by use of the CAN protocol. The ECUs 50, each of which serves as a node, are connected to each other with the communication bus 60. Each ECU 50 may be an engine ECU, a transmission ECU, an air conditioner ECU, or a navigation ECU or the like. The GW-ECU 40 serves as a relay device, and each of the ECUs 50 serves as a communication device.

When a high-level signal and a low-level signal are placed on the communication bus 60 simultaneously by at least two different ECUs of the ECUs 40, 50, a signal level on the communication bus 60 becomes the low level, which enables arbitrations between the ECUs 40, 50 connected to the communication bus 60.

The communications between the ECUs 50 are made by use of frames. Each frame, as a communication signal, includes a header for specifying transmission data, and a variable-length response for transmitting the data specified by the header. The header includes an identifier (ID) for the transmission data such that wining in a bus arbitration depends on a value of ID. The response includes the transmission data, data-size information indicative of a size of transmission data (i.e., a size of response), and a CRC code used to check for errors.

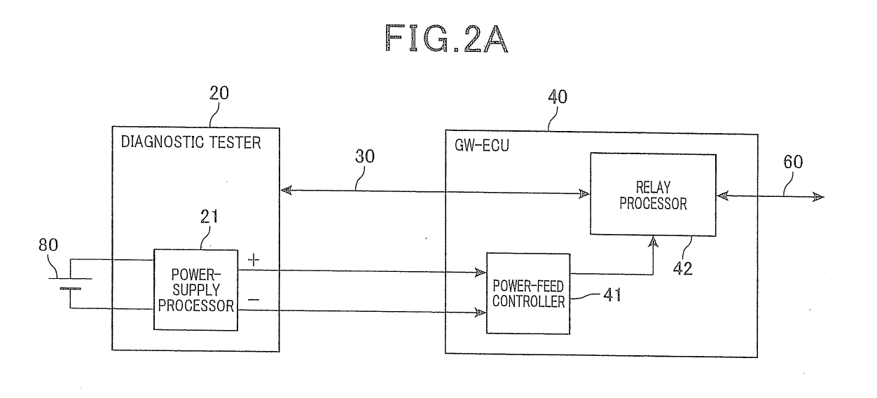

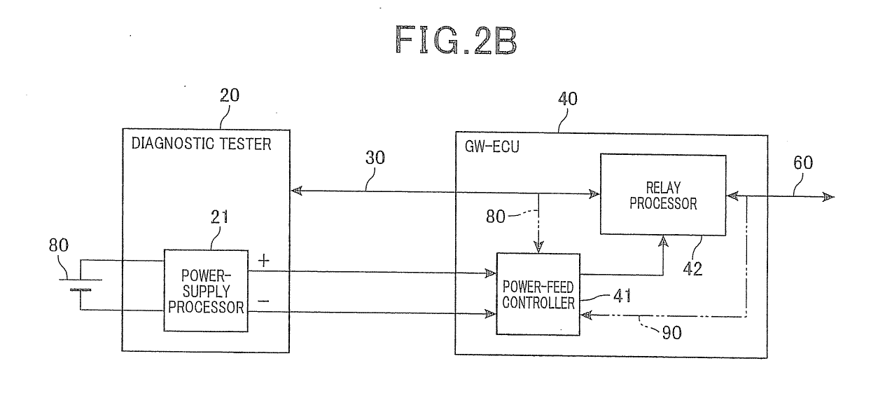

Given such an in-vehicle communication network 10, in the present embodiment, the GW-ECU 40 is powered by the diagnostic tester 20. FIG. 2A is a schematic block diagram focused on power feed from the diagnostic tester 20 to the GW-ECU 40.

As shown in FIG. 2A, the diagnostic tester 20 includes a power-supply processor 21. The power-supply processor 21 is supplied with power from an external power supply 80. The external power supply 80 may be a DC power supply or an AC power supply. The power-supply processor 21 may feed power in the form of a direct current or an alternating current to the GW-ECU 40.

The GW-ECU 40 includes a power-feed controller 41 and a relay processor 42. The power-feed controller 41 is supplied with power from the power-supply processor 21 of the diagnostic tester 20. The power-feed controller 41 transforms power received from the power-supply processor 21 to output the transformed power to the relay processor 42.

The relay processor 42 receives a frame from the diagnostic tester 20 via the communication path 30, and then identifies an ID included in the received frame to determine whether or not the ID is valid. If it is determined that the ID is valid, then the relay processor 42 forwards the frame to the communication bus 60. In addition, the relay processor 42 receives a frame via the communication bus 60, and then forwards the received frame to the diagnostic tester 20 via the communication path 30.

Upon initiation of power feed from the power-supply processor 21 of the diagnostic tester 20 to the GW-ECU 40, the power-feed controller 41 initiates power feed to the relay processor 42 of the GW-ECU 40. On the other hand, upon termination of power feed from the power-supply processor 21 of the diagnostic tester 20 to the GW-ECU 40, the power-feed controller 41 terminates power feed to the relay processor 42 of the GW-ECU 40.

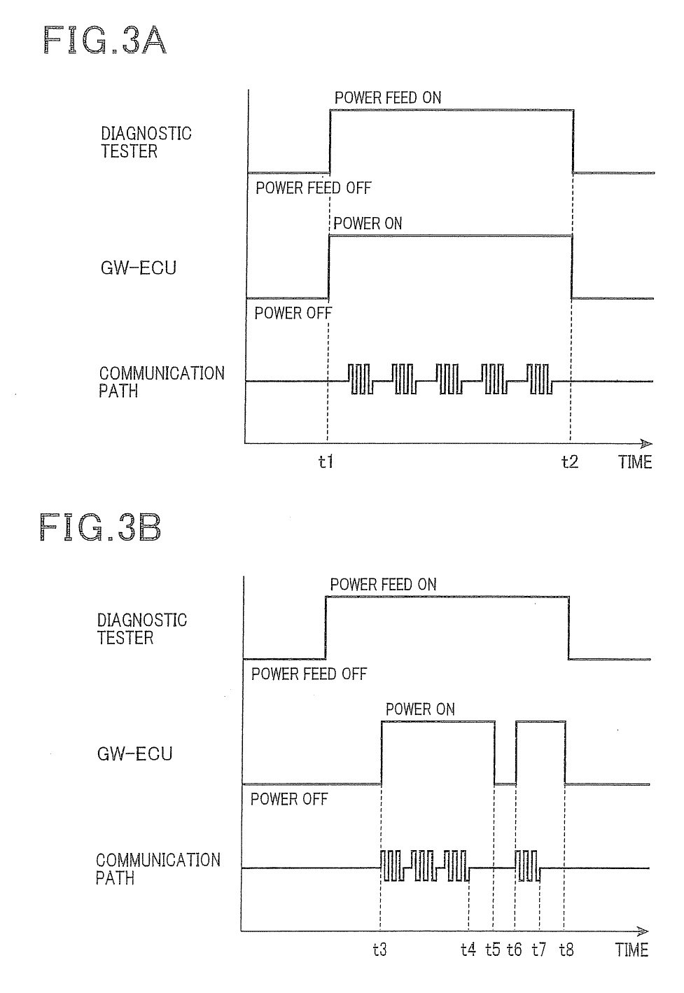

More specifically, as shown in FIG. 3A, upon initiation of power feed from the diagnostic tester 20 to the GW-ECU 40, power feed to the relay processor 42 of the GW-ECU 40 is initiated, and the GW-ECU 40 is thereby turned on (at the time t1). This enables data communications between the communication network 10 and the diagnostic tester 20 via the communication paths 30, 60. Subsequently, upon termination of power feed from the diagnostic tester 20 to the GW-ECU 40, the power feed to the relay processor 42 of the GW-ECU 40 is terminated, and the GW-ECU 40 is thereby turned off (at the time t2).

The power feed from the diagnostic tester 20 to the GW-ECU 40 may be initiated upon connection of the diagnostic tester 20 to the GW-ECU 40 or upon activation of the diagnostic tester 20 after connection of the diagnostic tester 20 to the GW-ECU 40. The power feed from the diagnostic tester 20 to the GW-ECU 40 may be terminated upon removal or disconnection of the diagnostic tester 20 from the GW-ECU 40 or upon deactivation of the diagnostic tester 20 while the diagnostic tester 20 is connected to the GW-ECU 40.

As described above in detail, as shown in FIG. 2A, the diagnostic tester 20 feeds power to the GW-ECU 40 that is a part of the communication network 10. Upon initiation of power feed from the power-supply processor 21 of the diagnostic tester 20 to the GW-ECU 40, the power-feed controller 41 of the GW-ECU 40 initiates power feed to the relay processor 42 of the GW-ECU 40. On the other hand, upon termination of power feed from the power-supply processor 21 of the diagnostic tester 20 to the GW-ECU 40, the power-feed controller 41 of the GW-ECU 40 terminates power feed to the relay processor 42 of the GW-ECU 40. With this configuration, the GW-ECU 40 can be activated upon connection of the diagnostic tester 20 to the GW-ECU 40, and can be deactivated upon removal of the diagnostic tester 20 from the GW-ECU 40, which leads to power saving in the diagnostic tester 20 and thus to power saving across the communication network.

### Second Embodiment

As described above, in the first embodiment, the GW-ECU 40 is turned on/off upon initiation/termination of power feed from the diagnostic tester 20 to the GW-ECU 40. There will now be explained a second embodiment where the power-feed controller 41 of the GW-ECU 40 performs a power-feed control process while being supplied with power from the diagnostic tester 20. Only differences of the second embodiment from the first embodiment will be explained.

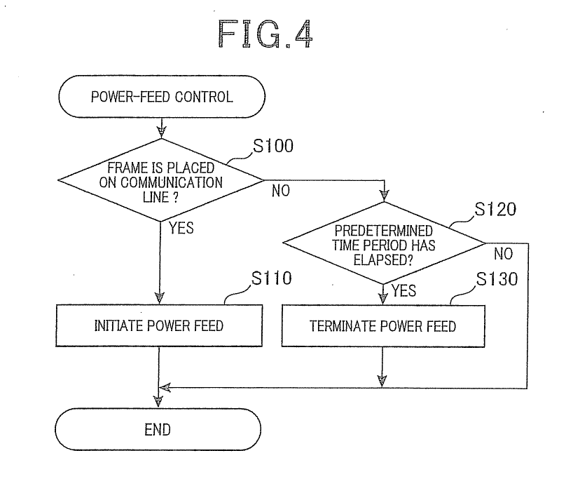

FIG. 4 is a flowchart for a power-feed control process performed by the power-feed controller 41 of the GW-ECU 40. After connection of the diagnostic tester 20 to the GW-ECU 40, the power-feed controller 41 performs the power-feed control process repeatedly while being supplied with power from the power-supply processor 21 of the diagnostic tester 20.

In the present embodiment, as shown by double dashed lines 80, 90 in FIG. 2B, the communication paths 30, 60 are both further connected to the power-feed controller 41 of the GW-ECU 40. First, in step S100, it is determined whether or not a frame is placed on at least one of the communication paths (or lines) 30, 60 on the basis of an electrical potential of each of the communication paths 30, 60. If it is determined in step S100 that a frame is placed on at least one of the communication paths 30, 60, then the process proceeds to step S110. On the other hand, if it is determined in step S100 that no frame is placed on the communication paths 30, 60, then the process proceeds to step S120.

In step S110, power feed to the relay processor 42 is initiated. Thereafter, the process is ended. In step S120, it is further determined whether or not a predetermined time period has elapsed since the last determination that a fame is placed on at least one of the communication paths 30, 60. If it is determined in step S120 that the predetermined time period has elapsed, then the power feed to the relay processor 42 is terminated in step S130. Thereafter, the process is ended. On the other hand, if it is determined in step 5120 that the predetermined time period has not elapsed yet, then the power feed to the relay processor 42 is maintained. Thereafter, the process is ended.

More specifically, as shown in FIG. 3B, if it is determined during power feed operation of the diagnostic tester 20 that a frame is placed on at least one of the communication paths 30, 60, then the power feed to the relay processor 42 of the GW-ECU 40 is initiated. The GW-ECU 40 is thereby turned on (at times t3, t6). This enables data communications between the in-vehicle communication network 10 and the diagnostic tester 20 via the communication paths 30, 60. Subsequently, if it is determined that the predetermined time period has elapsed since the last determination (at times t4, t7) that a fame is placed on at least one of the communication paths 30, 60, then the power feed to the relay processor 42 of the GW-ECU 40 is terminated. The GW-ECU 40 is thereby turned off (at the times t5, t8).

As described above in detail, in the present embodiment, the GW-ECU 40 is turned on just when a frame is placed on at least one of the communication paths 30, 60. With this configuration, the power feed to the relay processor 42 of the GW-ECU 40 is controlled on the basis of an electrical potential of each of the communication paths 30, 60 even during power feed operation of the diagnostic tester 20, which leads to more reliable power saving in the GW-ECU 40.

(Modifications)

There will now be explained some modifications of the first and second embodiments that may be devised without departing from the spirit and scope of the present invention.

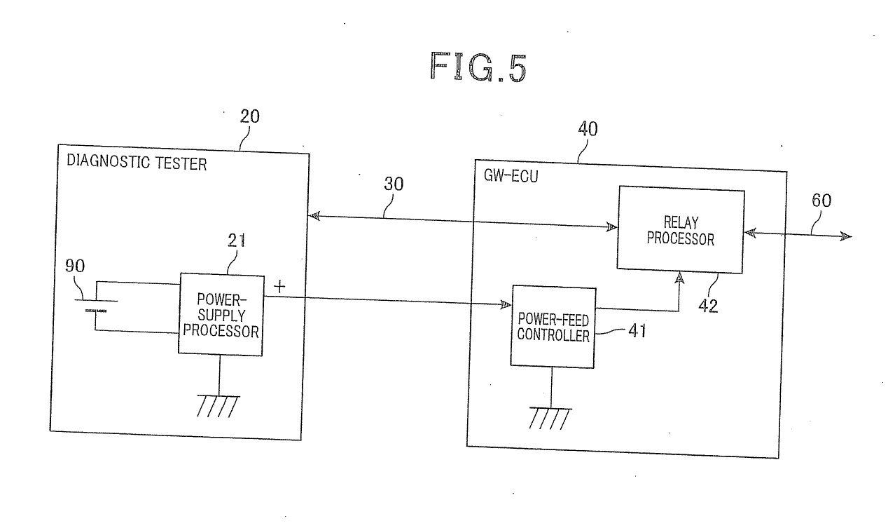

(i) In the first and second embodiments, as shown in FIGS. 2A, 2B, the power-supply processor 21 of the diagnostic tester 20 and the power-feed controller 41 of the GW-ECU 40 are electrically connected to common ground. Alternatively, as shown in FIG. 5, the diagnostic tester 20 and the GW-ECU 40 may be separately connected to ground.

(ii) In the first and second embodiments, as shown in FIGS. 2A, 2B, the power-supply processor 21 of the diagnostic tester 20 is supplied with power from the external power supply 80. Alternatively, as shown in FIG. 5, the diagnostic tester 20 may include an internal power supply 90 for supplying power to the GW-ECU 40.

(iii) In first and second embodiments, the power-feed controller 41 of the GW-ECU 40 transforms received power from the diagnostic tester 20 prior to feeding power to the relay processor 42. Alternatively, when the transformation is not necessary, the power-feed controller 41 may be removed.

(iv) In the first and second embodiments, communications over the communication paths 30, 60 are made by use of the CAN protocol. Alternatively, communications over the communication paths 30, 60 may be made by use of another communication protocol, such as the Ethernet® protocol. In addition, when the communication protocol of the communication path 30 and the communication protocol of the communication path 60 are different, the relay processor 42 may have to perform protocol conversion therebetween.

(v) In the first and second embodiments, as shown in FIG. 1, the network topology of the communication bus 60 is a bus network topology. Alternatively, the network topology of the communication bus 60 may be a star network topology or the like.

(vi) In the first and second embodiments, the GW-ECU 40 serving as a relay device has the relay function only. Alternatively, the GW-ECU 40 serving as a relay device may further include other functions. For example, an engine ECU having not only an engine control function, but also the relay function, may be a relay device.

(vii) In the first and second embodiments, the diagnostic tester 20 as an external device is connected to the in-vehicle communication network 10. Alternatively, for example, an external device may be connected to a communication network of a plurality of computers, or an external device may be connected to a gaming machine which includes a communication network for distributed processing.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A communications relay system for establishing data communications between an external device and a plurality of communication devices, the system comprising:
a communication path to which the plurality of communication devices are connected to form a communication network; and
a relay device connected to the communication path as a part of the communication network and operable to relay communications between the external device and the plurality of communication devices when being connected to and powered by the external device.

2. The system of claim 1, wherein the relay device is activated upon connection of the external device to the relay device.

3. The system of claim 1, wherein the relay device is deactivated upon removal of the external device from the relay device.

4. The system of claim 1, wherein the relay device comprises:
a relay processor that relays communications between the external device and the plurality of communication devices; and
a power-feed controller that controls power feed to the relay processor, the power-feed controller being operable to initiate the power feed to the relay processor upon initiation of power feed from the external device and terminate the power feed to the relay processor upon termination of the power feed from the external device.

5. The system of claim 1, wherein the communication path of the communication network is a first communication path, the relay device comprises:
a relay processor that relays communications between the external device and the plurality of communication devices; and
a power-feed controller that controls power feed to the relay processor on the basis of an electrical potential of each of the first communication path and a second communication path between the relay device and the external device, while being supplied with power from the external device.

6. The system of claim 5, wherein the power-feed controller determines whether or not a communication signal is placed on at least one of the first and second communication paths on the basis of an electrical potential of each of the first and second communication paths, and when it is determined that a communication signal is placed on at least one of the first and second communication paths, then initiates the power feed to the relay processor.

7. The system of claim 6, wherein the power-feed controller maintains the power feed to the relay processor in the presence of a communication signal placed on at least one of the first and second communication paths.

8. The system of claim 5, wherein the power-feed controller determines whether or not a communication signal is placed on at least one of the first and second communication paths on the basis of an electrical potential of each of the first and second communication paths, and when it is determined that no communication signal is placed on the first and second communication paths, then terminates the power feed to the relay processor.

9. The system of claim 1, wherein the communication network is mounted in a vehicle.

10. A relay device for relaying data communications between an external device and a plurality of communication devices, the relay device being connected to a communication path to which the plurality of communication devices are connected to form a communication network and being operable to relay communications between the external device and the plurality of communication devices when being connected to and powered by the external device.

11. The device of claim 10, wherein the relay device is activated upon connection of the external device to the relay device.

12. The device of claim 10, wherein the relay device is deactivated upon removal of the external device from the relay device.

13. The device of claim 10, wherein the relay device comprises:
a relay processor that relays communications between the external device and the plurality of communication devices; and
a power-feed controller that controls power feed to the relay processor, the power-feed controller being operable to initiate the power feed to the relay processor upon initiation of power feed from the external device and terminate the power feed to the relay processor upon termination of the power feed from the external device.

14. The device of claim 10, wherein the communication path of the communication network is a first communication path, the relay device comprises:
a relay processor that relays communications between the external device and the plurality of communication devices; and
a power-feed controller that controls power feed to the relay processor on the basis of an electrical potential of each of the first communication path and a second communication path between the relay device and the external device, while being supplied with power from the external device.

15. The device of claim 14, wherein the power-feed controller determines whether or not a communication signal is placed on at least one of the first and second communication paths on the basis of an electrical potential of each of the first and second communication paths, and when it is determined that a communication signal is placed on at least one of the first and second communication paths, then initiates the power feed to the relay processor.

16. The device of claim 15, wherein the power-feed controller maintains the power feed to the relay processor in the presence of a communication signal placed on at least one of the first and second communication paths.

17. The device of claim 14, wherein the power-feed controller determines whether or not a communication signal is placed on at least one of the first and second communication paths on the basis of an electrical potential of each of the first and second communication paths, and when it is determined that no communication signal is placed on the first and second communication paths, then terminates the power feed to the relay processor.

18. The device of claim 10, wherein the communication network is mounted in a vehicle.
